(19) United States
(12) Patent Application Publication
(10) Pub. No.: US 2019/0050870 A1
(43) Pub. Date: Feb. 14, 2019

(54) METHOD FOR PRODUCING, ENSURING, ACCESSING AND SELLING QUALITY DATA

(71) Applicant: Vissie Chen, Calgary (CA)

(72) Inventor: Vissie Chen, Calgary (CA)

(21) Appl. No.: 15/555,506

(22) PCT Filed: Aug. 11, 2015
(86) PCT No.: PCT/CA2015/050753

§ 371 Date: Sep. 3, 2017

(51) Int. Cl. G06Q 30/02; G06Q 30/06; G06Q 10/06

(52) U.S. Cl. CPC G06Q 30/0201; G06Q 10/063112; G06Q 30/0203; G06Q 30/0611

(57) ABSTRACT

A method for producing, ensuring, accessing and selling quality data on a communication network. A potential seller provides the requested quality data through a customized information system on a site, which generates a quality data package, linked to a number of predefined classification criteria. The potential seller sets a selling price and submits the quality data package for sale on the site. The customized information system attaches the price and the potential seller's screen name to the quality data package, and stores it in its database. To ensure quality of data being produced, existing quality control methods and the following measures can be used: a potential seller's commitment to provide quality data; special rules such as the restriction of only one quality data package available for sale at any time by a potential seller; a customized information system, and a potential buyer's preview of a limited version of randomly generated key parts of a quality data package prior to a purchase. A potential buyer can conveniently access quality data to make more informed decisions. A potential seller can conveniently share and make money from quality data being possessed.

### TECHNICAL FIELD

The present invention generally pertains to a method and system for producing quality data and generating revenue through electronic commerce (e-commerce) transactions conducted over a network, and more specifically, to a method and system for producing, ensuring, accessing and selling quality data over a network such as Internet.

### BACKGROUND ART

The present invention relates to a method for producing, ensuring, accessing and selling quality data on a communication network. To facilitate better illustration, the method for producing, ensuring, accessing and selling quality job insights over Internet is illustrated.

Choosing a career path, or changing an industry, a job location, a job title or an employer organization size, is a key decision that is likely to have long-lasting and pervasive effects on a person's life. So far, the methods and sources of obtaining related information to make such important decisions, together with their respective limitations, are shown as follows:

Observations and advices from parents: quality job insights can be available but are restricted to a few job titles, industries, job locations and employer organization sizes. For example, if a child wants a different career from his or her parents, or wants to work in a different country, the parents' job insights become much less useful.

Observations and advices from relatives, friends, teachers and other acquaintances: the scope, quality and availability of job insights are limited. For example, detailed salaries and benefits information may not be available. The job insights provided may not be accurate or objective. The job insights of a desired job title in another province may not be available.

Advices from online tests, psychologists, books and career advising lectures: the career or job decision is mainly based on a person's personalities and interests, which could turn out to be wrong. For example, a student may be interested in becoming an interpreter and studies for 4 years in a college to get such a job. However, after working a while as an interpreter, the person may find it frustrating because he or she prefers to spend more time with family but this type of job often requires frequent travelling.

Related information from Internet so far: a person can find a particular person's education, work history and skills on a professional networking web site, a particular job's duties, requirements and employer organization information on job searching web sites, a piece of information about a specific job title on an online forum such as work hours of an investment banker, and so forth. In general, the essential elements of quality job insights to facilitate an informed career or job decision, are scattered in many sources, the quality of which is questionable, or sometimes completely unavailable.

There is a need for quality job insights to be readily available in a single source and are produced in a structured way to facilitate a quicker and easier career or job comparison. There is a need for quality job insights to be produced in such a convenient way that as many quality job insights as possible can be available.

There is a need to control the quality of job insights being produced. Potential buyers are likely to want high quality job insights only.

There is need for potential buyers to conveniently access as many quality job insights as possible, of a desired job title in a desired industry and job location, for a desired employer organization size. If they can make much more informed career or job decisions at reasonable costs, the quality of their lives can be greatly improved.

There is a need for potential sellers to conveniently share and make money from their job insights. Potential sellers may want a convenient way to produce such job insights so that they do not have to be professional writers. Potential sellers may also want to be freed from the burden of marketing and selling their job insights.

### DISCLOSURE OF INVENTION

The present invention relates to a method for producing, ensuring, accessing and selling quality data on a communication network. A site on the network can be accessed locally, nationally or internationally. In particular, the present invention relates to a method over a communication network for:

Producing Quality Data for Sale on a Site:

A potential seller provides the requested quality data through a customized software on a site, which generates a quality data package that is linked to a number of predefined classification criteria. The potential seller sets a selling price and submits the quality data package for sale on the site. The customized software attaches the price and the potential seller's screen name to the quality data package, and stores it in its database.

The customized software is mainly made up of tailor-made forms, close-ended questions and open-ended questions. It has the functions of storing, classifying, retrieving and analyzing data. The customized software allows a potential seller to enter, edit or delete data, to preview a summary of entered data in a structured way, to set a selling price and to submit a data package for sale on a site. The customized software can link a data package to a number of predefined classification criteria, attach a selling price and a potential seller's screen name to a given data package, and store it in its database on a server hosting the site or other feasible means of storing such data.

The requested quality data are generally comprehensive in nature. For instance, the requested job insights can include but not limited to: industry; job title; job location; employer organization size; education, training and certificates; practical experience requirements; professional membership; brief previous work experience; salaries and benefits; work schedules; travel; work environment; physical demands; health and safety risks and concerns; insurance; possible future career paths; current industry trend for the supply and demand of such job; fun and frustrations at the job; personalities required by this job; skills vital to the job; a typical work day; and key success tips for this job.

The method for producing quality data for sale, solves the problem that quality data are not readily available in a single source. Take job insights as an example, the job insights obtained from existing methods and sources are limited in scope and of questionable quality. It demands tremendous time and efforts to put together available information to have a good career or job comparison. With the present invention, quality data such as job insights are comprehensive, accurate, objective, relevant and valuable. Quality data are available in a single source that is accessible by most potential buyers. Furthermore, quality data such as quality job insights are produced in a structured way to facilitate a quicker and easier data comparison such as career or job comparison.

With the present invention, quality data are produced in such a convenient way that as many quality data packages as possible can become available. A potential seller does not have to be a professional writer, or an expert in creating or designing a data package. The customized software determines the scope of quality data being produced and facilitates a professional appearance of a quality data package to be sold on a site. This makes it possible for a person with average writing skills and computer knowledge to become a potential seller. As a result, a large amount and variety of quality data packages can be produced and available for sale on a site.

Ensuring Quality of Data being Produced:

Existing quality control methods and the following measures are used: a potential seller's commitment to provide quality data; special rules such as the restriction of only one quality data package available for sale at any time by a potential seller; customized software; a potential buyer's preview of a limited version of randomly generated key parts of a quality data package prior to a purchase.

A potential seller's commitment to provide quality data, involves the procedures of requesting a potential seller to carefully read the rules and accept them. This indicates that a potential seller acknowledges the importance and obligations of providing accurate, objective, relevant and valuable data, to the potential seller's best knowledge.

Special rules such as the restriction of only one quality data package available for sale at any time by a potential seller, may be put in place to further improve the quality of data being produced. For example, it is assumed that at any time, a potential seller only possesses the most accurate, objective, relevant and valuable job insights of only one specific industry, one job title, one job location and one employer organization size.

A customized software is used to determine the scope of data being produced to ensure completeness of data. Existing application controls such as input controls and data validation are used by the customized software to ensure accuracy and validity of input data. The customized software also facilitates a professional appearance of a quality data package that may attract more potential buyers.

A potential buyer can preview a limited version of randomly generated key parts of a quality data package prior to a purchase. This not only assures a potential buyer of the quality of a data package and thus generates more sales, but also motivates a potential seller to provide higher quality data throughout the whole process of producing such a quality data package. The function is achieved by requesting answers to open-ended questions in a list of pre-numbered, separated text boxes in a customized software. A program can then execute a random selection of any combination of the answers.

The existing quality control methods can include but not limited to: manual reviews such as sampling quality data packages by experts for quality review; disclosure of accumulated number of purchases to a potential buyer; disclosure of customer ratings on a quality data package; penalties such as refusing access to the site for a given period of time and a fixed amount of fine.

Disclosure of accumulated number of purchases to a potential buyer not only helps a potential buyer make a quicker purchase decision, but also motivates a potential seller to provide higher quality data so that the potential seller can make more money.

Disclosure of customer ratings on a quality data package involves the steps of collecting, storing, summarizing and disclosing customer ratings to a potential buyer. The customer ratings may use a 5 star rating scale, covering accuracy, objectiveness, relevance and usefulness of a quality data package. A discount on next purchase, credits or reward points may be offered to attract more customer feedback.

These methods of quality control, either used separately or in any combination, help ensure the quality of data being produced. This solves the problem that related data obtained through existing sources are of questionable quality. These measures are critical because potential buyers only want to pay for data of high quality.

Conveniently Accessing Unlimited Quality Data at Reasonable Costs:

the potential buyers of quality data are people who want to make more informed decisions. A potential buyer accesses a site on the network and provides desired search criteria through an advanced search tool. The site displays a list of matching quality data packages, each uniquely identified by the seller's screen name, together with its customer ratings, accumulated number of purchases, selling price and a preview button. The potential buyer can then preview a limited version of randomly generated key parts of a quality data package, and review its customer ratings and number of accumulated purchases. The potential buyer may add a selected quality data package to the shopping cart, proceed to checkout and make a payment.

To facilitate better illustration, quality job insights are used as an example of quality data. The potential buyers of quality job insights can be students who want to choose a career based on more useful job insights, or workers who want to make more informed decisions when they are contemplating a change in industry, job title, job location or employer organization size. The existing methods of obtaining a career or job related information, require a person to observe, arrange a face-to-face meeting with, phone or send messages to parents or acquaintances, or access many web sites and struggle to put together some relevant information. With the present invention, potential buyers can easily access a single web site to obtain unlimited quality job insights of a desired industry, job title, job location and employer organization size, at any time, from anywhere, at reasonable costs. Since the job insights packages are produced in a structured way, a potential buyer can make a quicker and easier career or job comparison. As a result, a potential buyer may make a better career or job decision more efficiently, which could have long-lasting and pervasive positive effects on the buyer's life.

Conveniently Sharing and Making Money from Quality Data being Possessed:

The potential sellers can be people who want to help others make more informed decisions and make money for doing so. A potential seller provides the requested quality data through a customized software on a site, sets his or her desired selling price and submits a quality data package for sale on the site.

To facilitate better illustration, the example of selling quality job insights is illustrated. The potential sellers can be workers who want to help the young generation make better career choices or help other workers make more informed job decisions. According to existing methods, workers who possess such valuable job insights may offer some information to a very limited number of audience, either completely for free, or for little rewards such as a free coffee or free meal. With this invention, a potential seller can share with unlimited audience and make uncapped money from his or her job insights. A potential seller has the freedom of setting his or her desired selling price and making uncapped money, which also motivates him or her to provide higher quality job insights.

A potential seller may publish a book about his or her job insights, but this requires the potential seller to be a professional writer and to handle the marketing and selling of the book. With this invention, a worker with average writing skills and computer knowledge can produce a quality job insights package through a customized job insight software for sale on a site. The potential seller will also be freed of the burden of marketing and selling a job insights package, since the site handles the marketing and selling of all job insights packages.

The method for producing, ensuring, accessing and selling quality data forms a single general inventive concept. The method for producing quality data for sale makes it possible for many potential sellers to sell quality data being possessed, for buyers to conveniently access such quality data, and is an essential method for ensuring quality of data being produced. The methods for ensuring quality of data being produced make data valuable, that are desired by potential buyers and thus can be sold by potential sellers, and make it worthwhile to produce such data. The method for accessing quality data brings in many potential buyers. Consequently, a potential seller can share with unlimited audience and make uncapped money from quality data being possessed. This encourages a potential seller to use a customized software to produce a quality data package for sale and comply with all applicable quality control measures. The method for selling quality data is an integral part because, without potential sellers, quality data packages cannot be produced by a customized software. In that case, potential buyers cannot access such quality data, making the process of producing quality data for sale and measures of ensuring quality of data to be of little value.

### BRIEF DESCRIPTION OF DRAWINGS

FIG. 1 shows the system for accessing the site.

FIG. 2 shows the flow diagram for producing a quality data package for sale on a site.

FIG. 3 shows the flow diagram for producing a quality job insights package for sale on a site.

FIG. 4 shows the flow diagram for accessing and buying quality job insights packages.

FIG. 5 shows an example page of a customized job insights software.

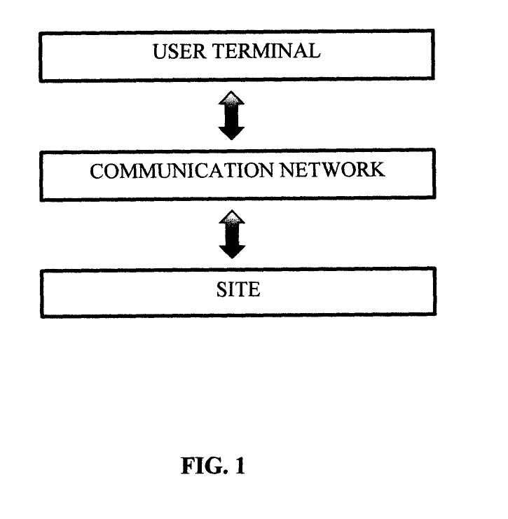

FIG. 1 shows a network for practicing the invention. A user terminal accesses the site over a communication network. The user terminal can be a personal computer (PC) such as a desktop computer or laptop computer, a PDA, a cell phone or any other device that transmits and receives data. The communication network can be a Local Area Network (LAN), Wide Area Network (WAN), wireless network, wired network, Public Switched Telephone Network (PSTN), intranet, extranet, or Internet. The user terminal can connect to the communication network using Ethernet, dial-up, DSL, cable, satellite, wireless, wired or any other connecting system. The site can be located anywhere on the network. In one embodiment, the user terminal is a PC that accesses a web site hosted by a server over the Internet. The web site can be created by any web site tool such as Microsoft FrontPage.

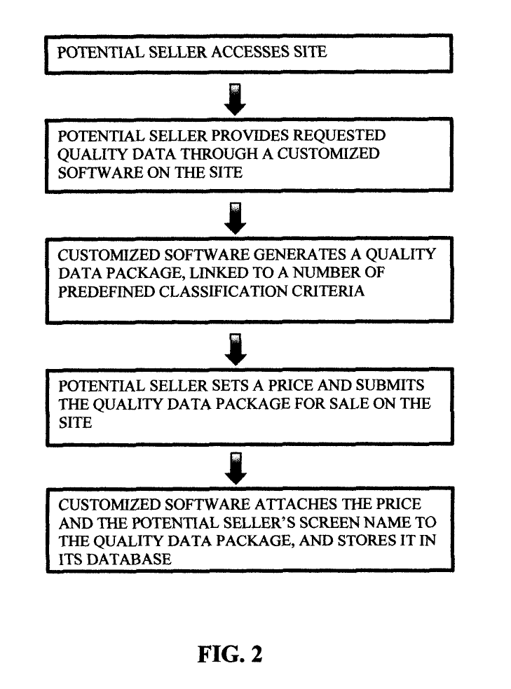

FIG. 2 shows the method for practicing the invention. A user accesses a site. The site displays Buy and Sell icons. The user selects Sell icon. The site displays rules, terms of use, seller's guide and request for registration. A previously registered potential seller can just enter a screen name and password to log in. A new potential seller has to create a unique screen name and a password, and enter the contact information and necessary details to receive payments for the sale of his or her quality data packages on the site. The contact information can include any of a name, mailing address, email address, telephone number or any other information that can be used to contact the potential seller. The necessary details to receive payments from the site can include the details of a bank account or any other convenient means of receiving payments by a potential seller. After a potential seller registers, the site displays request for quality data through a customized software. The customized software is mainly made up of tailor-made forms, close-ended questions and open-ended questions. The answers to open-ended questions are requested in a list of pre-numbered, separated text boxes to facilitate a random selection of any combination of the answers, which will be presented to a potential buyer prior to a purchase. The requested quality data are comprehensive in nature, covering almost all key aspects of a subject matter. The potential seller provides the requested data, previews, edits and confirms a preliminary version of a quality data package. The customized software generates a quality data package, linked to a number of predefined classification criteria for the quality data package to be most useful. The site displays request for a selling price and pricing advices. The potential seller sets a desired price and submits the quality data package for sale on the site. The customized software attaches the price and the potential seller's screen name to the quality data package, and stores it in its database on a server hosting the site or any other feasible means of storing such data. The potential seller may access his or her user account to view, update or delete a quality data package, to track sales quantity and sales revenue, to perform general account maintenance, or just log out and leave the site.

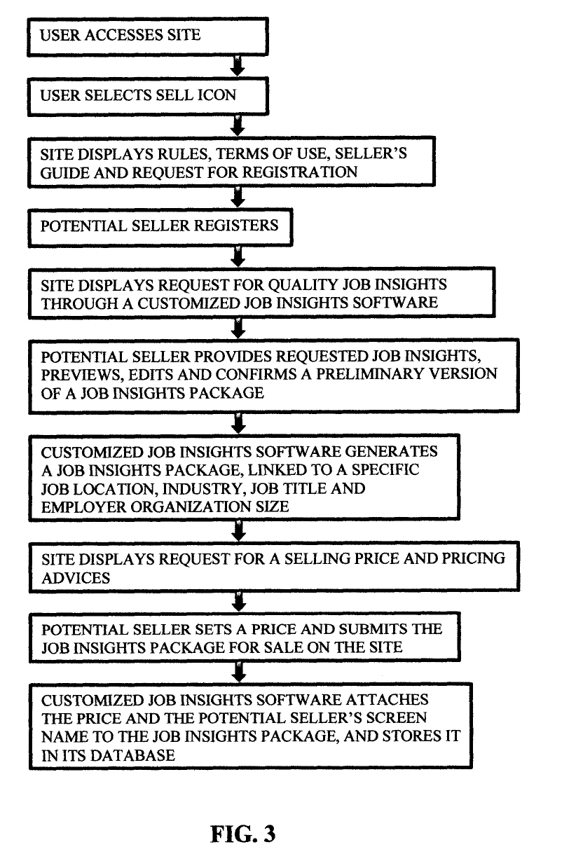

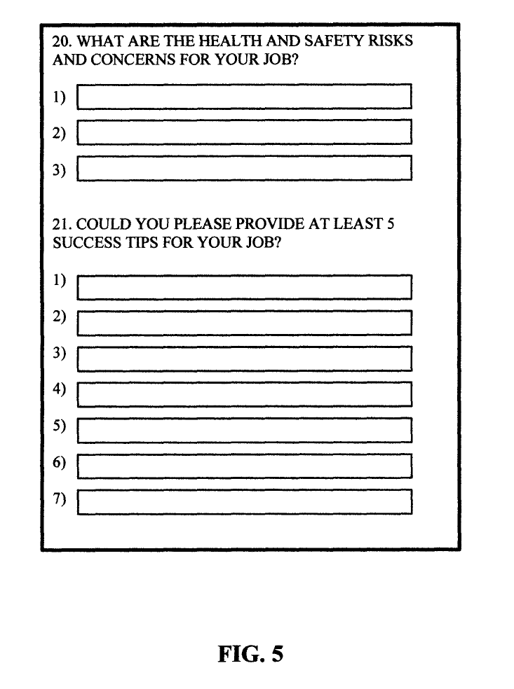

FIG. 3 shows the method for producing a quality job insights package for sale on a site. A user accesses a site. The site displays Buy and Sell icons. The user selects Sell icon. The site displays rules, terms of use, seller's guide and request for registration. A potential seller either registers or logs in. After a new potential seller registers, the site displays request for quality job insights through a customized job insights software. FIG. 5 shows an example of such a page displayed by a customized job insights software. The requested quality job insights are comprehensive in nature, covering almost all key aspects of a specific job in a specific industry and job location, of a specific employer organization size. The potential seller provides the requested job insights, previews, edits and confirms a preliminary version of a quality job insights package. The customized job insights software generates a quality job insights package, linked to a specific industry, job title, job location and employer organization size for the quality job insights package to be most useful. The site displays request for a selling price and pricing advices. The potential seller sets a desired price and submits the quality job insights package for sale on the site. The customized job insights software attaches the price and the potential seller's screen name to the quality job insights package, and stores it in its database on a server hosting the site or any other feasible means of storing such data.

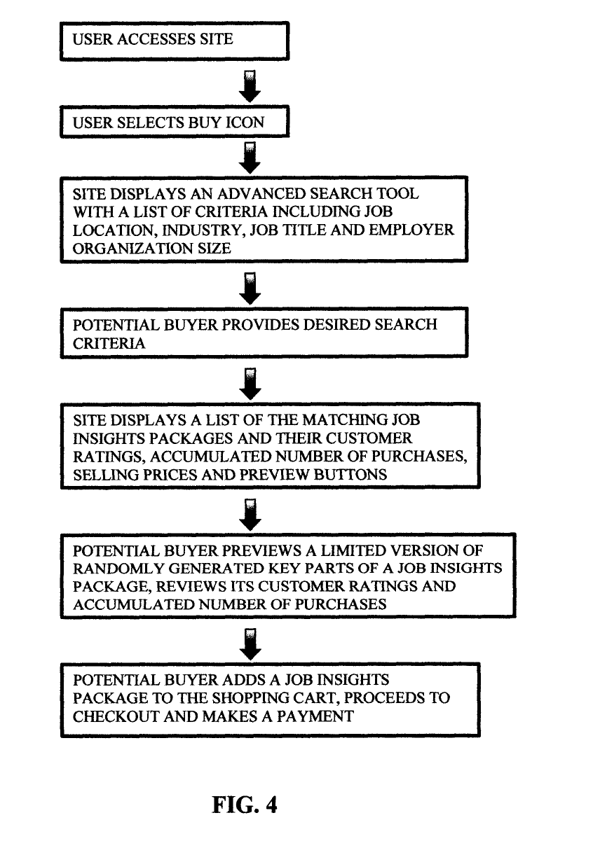

FIG. 4 shows the flow diagram for accessing and buying quality job insights packages. A user accesses a site. The site displays Buy and Sell icons. The user selects Buy icon. The site then displays an advanced search tool with criteria that include but not limited to: job location, industry, job title and employer organization size. The potential buyer provides desired search criteria. The site displays a list of matching job insights packages. The potential buyer can select the Preview button to preview a limited version of randomly generated key parts of a job insights package. The site also displays customer ratings, accumulated number of purchases and the selling price of each job insight package to help a potential buyer make a quicker decision. A potential buyer can add a job insight package to the shopping cart, proceed to checkout and make a payment. After a successful purchase, the full version of the purchased job insights package will be available for the buyer to download.

### BEST MODE FOR CARRYING OUT THE INVENTION

According to another embodiment of the present invention, quality data is best to be in high demand by unlimited potential buyers and widely held by many potential sellers. The quality data should not be readily available in existing sources.

According to another embodiment of the present invention, a communication network is best to be the Internet, which is used by unlimited number of potential buyers and potential sellers of quality data.

According to another embodiment of the present invention, a site is best to be an international responsive website to attract as many potential buyers and potential sellers as possible.

According to another embodiment of the present invention, a customized software is best to be very user-friendly for most Internet users. It can produce a quality data package for sale on a site, but is best to have limited features so that it can be embedded in or attached to a site easily. It can be a web-based application that is accessible by multiple types of website browsers, that is independent of the end users' computer operating systems, and that is responsive for users of tablets and other mobile devices.

According to another embodiment of the present invention, a potential seller is best to possess quality data, have average writing skills and computer knowledge to provide the requested quality data through a customized software, and want to help others make more informed decisions and make more money.

According to another embodiment of the present invention, a user may be required to pay a fee to sell a quality data package on a site. A set fee can be charged before the user submits a quality data package for sale. Alternatively, the fee can be a percentage of the price that a quality data package is advertised or sold.

1. A method and system to facilitate direct commercial exchange of intelligence information in a particular area of interest among unlimited outside intelligence information sellers and buyers on a communication network. The intelligence information being commercially exchanged is organized into a quality data package, which is produced instantly onsite with quality raw data input directly from an outside intelligence information seller through the special-purpose customized software, which is specifically designed to cover comprehensive aspects of intelligence information in a particular area of interest. The inventive steps comprise:
a) characterized by the special-purpose customized software requesting quality raw data input directly from an outside intelligence information seller;
b) characterized by the outside intelligence information seller providing the requested quality raw data, editing, previewing and confirming a preliminary version of a quality data package;
c) characterized by the special-purpose customized software instantly generating a quality data package onsite, automatically tagging it with a number of predefined classification criteria;
d) characterized by the same special-purpose customized software on the site automatically requesting a selling price, with tips from the site to help the outside intelligence information seller to set a proper and realistic selling price;
e) characterized by the outside intelligence information seller setting a desired selling price and submitting the quality data package for sale on the same site;
f) characterized by the same special-purpose customized software automatically attaching the selling price to the quality data package, and using the outside intelligence information seller's unique username as the identifying name of the quality data package, and storing it in its database.

2. The method and system to facilitate direct commercial exchange of intelligence information in a particular area of interest among unlimited outside intelligence information sellers and buyers on a communication network in accordance with claim 1, the steps further comprising:
g) a potential outside intelligence information seller accessing a site with the built-in special-purpose customized software on a communication network and selecting the Sell icon;

3. The method and system to facilitate direct commercial exchange of intelligence information in a particular area of interest among unlimited outside intelligence information sellers and buyers on a communication network in accordance with claim 1, the steps further comprising:
h) the site displaying rules, terms of use, seller's guide and a request for an outside intelligence information seller to register a user account, which includes choosing a unique username and a safe password, as well as providing sufficient contact information and necessary details to receive payments for selling a quality data package on the site.

4. The method and system to facilitate direct commercial exchange of intelligence information in a particular area of interest among unlimited outside intelligence information sellers and buyers on a communication network in accordance with claim 1, the inventive steps further comprising:
i) characterized by the site charging outside intelligence sellers fees for providing the special-purpose customized software to assist them producing their quality data packages from raw data, and for marketing and selling their quality data packages on the site, either by charging a set fee before an outside intelligence information seller submitting a quality data package, or by charging a percentage of the selling price when a quality data package is sold.

5. The method and system to facilitate direct commercial exchange of intelligence information in a particular area of interest among unlimited outside intelligence information sellers and buyers on a communication network in accordance with claim 1, the steps further comprising:
j) outside intelligence information sellers accessing their user accounts to view, update or delete their own quality data packages, to track sales quantity and sales revenue, to perform general account maintenance or logging out.

6. The method and system to facilitate direct commercial exchange of intelligence information in a particular area of interest among unlimited outside intelligence information sellers and buyers on a communication network in accordance with claim 1, wherein the special-purpose customized software to produce a quality data package instantly onsite is best to run as a web application which could not be downloaded or used offline by any outside user. The special-purpose customized software is best to be very user-friendly with limited features. The site to facilitate direct commercial exchange of intelligence information between unlimited outside intelligence sellers and buyers is best to be a responsive website while the communication network is best to be the Internet.

7. The method and system to facilitate direct commercial exchange of intelligence information in a particular area of interest among unlimited outside intelligence information sellers and buyers on a communication network in accordance with claim 1, wherein the quality raw data being requested directly from an outside intelligence information seller is characterized in that it generally covers comprehensive aspects of the intelligence information being commercially exchanged in a particular area of interest. For instance, the requested job insights can include but not be limited to: industry; job title; job location; employer organization size; education, training and certificates; practical experience requirements; professional membership; brief previous work experience; salaries and benefits; work schedules; travel; work environment; physical demands; health and safety risks and concerns; insurance; possible future career paths; current industry trend for the supply and demand of such job; fun and frustrations at the job; personalities required by the job; skills vital to the job; a typical work day; and key success tips for the job. The quality raw data is best to be in high demand by many buyers and widely held by unlimited potential outside intelligence information sellers, which should not be readily available in existing sources.

8. The special-purpose customized software to produce quality data packages instantly onsite with quality raw data input directly from unlimited outside intelligence information sellers, is characterized in that it is mainly made up of a series of special-purpose tailor-made forms with both close-ended questions and open-ended questions, which are specifically designed to cover comprehensive aspects of the intelligence information being commercially exchanged in a particular area of interest. The forms have fixed content and fixed structures that could not be modified by its intended users (outside intelligence information sellers). Through the special-purpose customized software, an outside intelligence information seller can input, edit and delete raw data, preview a summary of entered raw data structured as a preliminary version of a quality data package, set a selling price, and submit a quality data package for sale on the same site with the built-in special-purpose customized software. The special-purpose customized software can generate a quality data package, tag it with a number of predefined classification criteria, attach a selling price and use the outside seller's unique screen name as the identifying name of the quality data package, and store it in its database. The special-purpose customized software can store, classify, retrieve and analyze quality data.

11. Technical features of the special-purpose customized software in accordance with claim 8 for ensuring the comparability, completeness, accuracy, objectiveness, relevance and usefulness of quality data packages being produced instantly onsite with quality raw data input directly from unlimited outside intelligence information sellers through the special-purpose customized software, characterized in that
a) the special-purpose customized software is mainly made up of a series of tailor-made forms with fixed content and fixed format, which are non-adaptive and could not be changed by outside intelligence information sellers, in order to produce consistent, objective and comparable quality data packages with professional fixed structures for users to easily understand and compare across different quality data packages;
b) the special-purpose customized software defines the scope of quality raw data being collected to ensure that all of the essential comprehensive raw data is being collected and that only necessary and relevant raw data is being collected;
c) the special-purpose customized software is equipped with input controls and validation tools to ensure the accuracy and validity of raw data input;

12. A method and system for ensuring high quality of quality data packages being produced instantly onsite with quality raw data input directly from unlimited outside intelligence information sellers through the special-purpose customized software in accordance with claim 8, characterized in that upon the request of a potential buyer during sales, a special computer program randomly selects some key parts of a quality data package to produce a randomly generated limited version of the quality data package, and displays it to the potential buyer prior to purchase. The inventive steps comprise:
a) characterized in that when designing the special-purpose customized software, pre-number all of the close-ended questions and open-ended questions using the same first-level numbering system;
b) characterized in that when designing the special-purpose customized software, request the answers to open-ended questions in a list of separate textboxes, and pre-number each textbox with the same second-level numbering system;
c) characterized by configuring a special computer program in the special-purpose customized software or as a separate independent program on the site, which can execute a random selection of any combination of the answers to some open-ended questions and/or close-ended questions;
d) characterized by the special computer program instantly executing a random selection of some key parts of the quality data package when a potential buyer clicks on the Preview tool icon next to a quality data package;
e) characterized by the special computer program displaying a randomly generated limited version of the quality data package to the potential buyer.

19. A quality data package produced through the special-purpose customized software as described in claim 8 with additional technical features as described in claim 11, using the method and system as described in claim 1, with its quality being ensured by any one or more combination of claim 11, claim 12, and.

20. A method and system for intelligence information buyers to conveniently access unlimited valuable quality data packages as described in claim 19 on a single site at reasonable costs and to make an easy and quick comparison across different quality data packages, the inventive step comprising of:
a) characterized by a potential buyer accessing a site with the built-in special-purpose customized software that can produce quality data packages instantly onsite with quality raw data input directly from unlimited outside intelligence sellers on a communication network, and selecting the Buy icon;
b) characterized by a potential buyer providing one or more desired key word(s) in a list of separate search boxes with predefined search criteria that correspond to the predefined classification criteria tagged by the special-purpose customized software on each quality data package;
c) characterized by the site displaying all of the matching quality data packages to the potential buyer, together with the previous buyers' ratings, the number of accumulated successful transactions, the selling price and the Preview button of each matching quality data package;
d) characterized by a potential buyer clicking on Preview tool icon next to a quality data package, and a special computer program on the site instantly executing a random selection of some key parts of the quality data package and displaying the randomly generated limited version of the selected quality data package to the potential buyer prior to a purchase;

21. A method and system for intelligence information buyers to conveniently access unlimited valuable quality data packages as described in claim 19 on a single site at reasonable costs and to easily compare different quality data packages in accordance with claim 20, the steps further comprising:
e) a potential buyer adding one or more quality data package(s) to the shopping cart of the site, proceeding to checkout and making a payment.

22. A method and system for intelligence information buyers to conveniently access unlimited valuable quality data packages as described in claim 19 on a single site at reasonable costs and to easily compare different quality data packages in accordance with claim 20, the steps further comprising:
f) after successful payment, the buyer accessing a link to view and download the full version of the purchased quality data package.

23. A method and system for intelligence information buyers to conveniently access unlimited valuable quality data packages as described in claim 19 on a single site at reasonable costs and to easily compare different quality data packages in accordance with claim 20, the steps further comprising:
g) the buyer simultaneously opening two or more purchased quality data packages side-by-side and making an easy and quick comparison.

24. A method and system to convert unlimited outside intelligence information possessors into sellers, who can conveniently share intelligence information with unlimited audience and make uncapped money, without worrying about their writing skills, or creating and designing a data package, or the marketing and selling of their intelligence information, the inventive steps comprising:
a) characterized by a potential outside intelligence information seller accessing a site with a built-in special-purpose customized software on a communication network and selecting the Sell icon;
b) characterized by the outside intelligence information seller providing the requested quality raw data through the special-purpose customized software, previewing, editing and confirming a preliminary version of a quality data package;
c) characterized by the special-purpose customized software instantly generating a professional-look quality data package onsite;
d) characterized by the outside intelligence information seller setting a selling price, and submitting the quality data package for sale on the same site;
e) characterized by the site handling the marketing and selling of all quality data packages for outside intelligence information sellers.
